(19) United States
(12) Patent Application Publication
(10) Pub. No.: US 2011/0114266 A1
(43) Pub. Date: May 19, 2011

(54) DEVICE FOR APPLYING ADHESIVE

(75) Inventors: Lars Petersen, Kvistgaard (DK); Sten Thornberg, Haarlev (DK)

(73) Assignee: SIKA TECHNOLOGY AG, Baar (CH)

(21) Appl. No.: 13/002,827

(22) PCT Filed: Jul. 14, 2009
(86) PCT No.: PCT/EP2009/058939

§ 371 Date: Jan. 31, 2011

(30) Foreign Application Priority Data
Jul. 14, 2008 (EP) 08160313.6

(51) Int. Cl. B32B 37/12; B05B 1/34; B05D 5/10; B05D 1/00; B05C 11/00

(52) U.S. Cl. 156/497; 118/58; 427/207.1

(57) ABSTRACT

A device for applying adhesive having both an adhesive distribution housing comprising a plurality of adhesive discharge nozzles and at least one gas discharge nozzle disposed in the longitudinal axis of the adhesive distribution housing. Fundamental advantages are created by a simple, inexpensively-implemented constructive design for the device, thereby enabling expensive ancillary equipment either to be eliminated or at least significantly reduced in scope. Due to the advantageous manner of application, the invention succeeds in avoiding material wastage, while also achieving to the greatest extent possible a full-coverage, homogenous distribution of the adhesive.

### TECHNICAL FIELD

The invention relates to the field of devices for applying adhesives.

### PRIOR ART

An extremely wide variety of devices is available for applying and distributing adhesives on planar substrates.

In terms of large areas, adhesives are often applied to planar substrates to be bonded using devices that have a plurality of nozzles to discharge the adhesive. The adhesive exits through spaced nozzles from the distribution device and is applied in the form of individual beads on the substrate by moving the device parallel to the surface. For example, WO 99/65612 A1 discloses such an adhesive-applying device. The disadvantageous aspect in using this type of distribution device for applying the adhesive, however, is that the adhesive is frequently applied inhomogeneously due to the fact that individual isolated beads are present on the surface, and this results in a defective adhesive bond after joining is effected. This occurs particularly in situations involving porous or elastic substrates that are difficult to press together.

An adhesive can also be applied using a wide-slit nozzle. However, due to the viscosity of the adhesive and the nozzle geometry, it is very difficult to ensure that the flow of adhesive exiting the wide-slit nozzle is homogeneous across the entire width and is distributed uniformly over the surface to be bonded. Whenever planar substrates are bonded over their entire surface or over their full area, the wide-slit nozzle must also project beyond the edge, thereby necessarily resulting in an increase in material consumption and waste. Adhesive can also be sprayed onto a surface. In this case, the adhesive is mixed inside a spray nozzle with a spray gas and then applied to the surface. However, these spray nozzles at times are, first of all, of very complex design and/or also extremely susceptible to types of contamination, and as a result are very labor-intensive in terms of maintenance and cleaning. Additionally, it is difficult to restrict the location of the adhesive when using this method due to the spray mist that is generated. Material is thus applied to locations where it is not at all required, or even desirable, and this situation results in an increase in the consumption of material, or an increase in the cost of removing waste. In addition, the presence of the spray mist results in extensive contamination and entails significant health risks—especially if the adhesive contains reactive substances, in particular, those that are hazardous to health. Expensive filters and suction devices are thus required in association with these spray systems. All of the above generates significant and undesirable added costs.

### DESCRIPTION OF THE INVENTION

The object of this invention is therefore to provide a device that simply and easily enables an adhesive to be applied to and distributed over a planar substrate, and allows the quantity of waste and/or any health hazards created during the application to be reduced.

Surprisingly, it is found that a device as set forth in Claim 1 and/or a method as set forth in Claim 11 can achieve this object.

The invention enables the adhesive to be applied quickly over a large area of a planar substrate. Fundamental advantages are created by a simple, inexpensively-implemented constructive design for the device, and these allow expensive ancillary equipment either to be eliminated or at least significantly reduced in scope. Due to the advantageous manner of application, the invention succeeds in avoiding material wastage, while also achieving to the greatest extent possible a full-coverage, homogenous distribution of the adhesive.

It has been found that the device can be used especially effectively for bonding planar substrates, as set forth in Claim 15.

The subordinate claims provide advantageous embodiments, improvements, and developments of the device indicated in Claim 1, of the method indicated in Claim 11, and of the use indicated in Claim 15.

The core principle of the invention is an approach whereby adhesive emerging through adhesive discharge nozzles is distributed by one or more gas jets directed at the emerging adhesive, thereby achieving a homogeneous distribution of the adhesive on the substrates to be bonded.

This invention thus relates in terms of a first aspect to a device for applying adhesive that has a longitudinal adhesive distribution housing comprising a plurality of adhesive discharge nozzles and at least one adhesive inlet orifice. The adhesive discharge nozzles are spaced at intervals along one side of the adhesive distribution housing. In addition, the device has at least one gas inlet orifice as well as at least one gas discharge nozzle disposed in the longitudinal axis of the adhesive distribution housing. This gas discharge nozzle is part of the adhesive distribution housing, or it is connected to this housing and is connected to the gas discharge orifice.

The essential aspect here is that the directional axis of outflow for the adhesive discharge nozzles and the directional axis of outflow for the gas discharge nozzle describe an acute angle α. In other words, the gas discharge nozzle is oriented such that gas exiting this nozzle during the application of adhesive is directed at the adhesive emerging through the adhesive discharge nozzles at a distance from the adhesive discharge nozzles or gas discharge nozzle(s) and hits impacts the adhesive.

Within the scope of this document, the term “nozzle” applies to any discharge orifice that narrows down in the direction of flow of the media.

It is essential here that at least one such gas discharge nozzle be provided. Preferably, however, at least two gas discharge nozzles are provided.

In an especially preferred approach, the device has at least two gas discharge nozzles that are disposed in the longitudinal axis of the adhesive distribution housing on different sides of the adhesive discharge nozzles.

In principle, any gas can be used. Inert gases, nitrogen, and air are especially suitable. The preferred gases to be used are nitrogen and air. Nitrogen and dry air are especially preferred. Inert gases are advantageous primarily when applying reactive adhesives in order to preclude any undesirable reactions in the adhesive.

In a preferred embodiment, the gas discharge nozzles are designed as a longitudinal nozzle.

Gas discharge nozzles are especially preferred that have a discharge orifice where the discharge orifice area has a length-to-width ratio of more than 10, in particular, 100 up to 4,000—preferably between 1,000 and 3,000.

The gas discharge nozzle can be part of the adhesive distribution housing, or it can be connected to this housing. Bolting the gas discharge nozzle(s) to the adhesive distribution housing has been found to be advantageous.

In principle, the nozzles can also be disposed a certain distance removed from the adhesive distribution housing. However, in this case they are connected to the adhesive distribution housing in such a way that the relative position between gas discharge nozzle(s) and adhesive distribution housing is fixed and can thus be moved together. This embodiment can be implemented, for example, using a rod linkage to which the adhesive distribution housing and the gas discharge nozzle(s) are attached—for example, by a bolt/screw-type connection or by welding them on.

The preferred approach, however, is to attach the gas discharge nozzle(s) to the adhesive distribution housing directly, in particular, by bolting them together.

The gas discharge nozzle(s) are normally part of a gas nozzle housing.

In certain cases it may be appropriate to dispose multiple gas discharge nozzles side-by-side along the longitudinal axis of the adhesive distribution housing. This approach enables multiple nozzles to be disposed in the longitudinal axis of the adhesive distribution housing, which nozzles have different orientations and/or gas discharge rates or pressures. This can be especially advantageous in terms of optimizing the distribution of the adhesive.

In an especially preferred embodiment, the gas discharge nozzle is created by a gap that is formed by joining at least one gas nozzle housing to the adhesive distribution housing. Here the gas nozzle housing has a cutout in the region of the nozzle, thereby forming a gap between adhesive distribution housing and gas nozzle housing, the gap functioning as the gas discharge nozzle.

It is especially easy in this variant to create very narrow gas discharge nozzle(s). It has been found that a gap ranging from 0.01 mm to 1 mm, in particular, from 0.05 mm to 0.5 mm is especially effective.

The device has a plurality of adhesive discharge nozzles that are spaced along one side of the adhesive distribution housing. The discharge orifice of the adhesive discharge nozzles can be designed in a wide variety of ways. In particular, it can be slit-like, oval, or round. A round discharge orifice for the adhesive discharge nozzles is preferred.

The plurality of the adhesive discharge nozzles is disposed in the longitudinal axis of the adhesive distribution housing. The preferred approach is to dispose them in at least one row. The generally preferred approach is to dispose them in at least two rows arranged in parallel.

The size, number, and spacing of the individual adhesive discharge nozzles is highly dependent on the viscosity of the adhesive, and the rate of application and the thickness of the adhesive layer to be achieved.

It has been found that a spacing is especially appropriate between the individual adhesive discharge nozzles that is, in particular, between double and five times the nozzle diameter. The (smallest) diameter of the adhesive discharge nozzles is preferably between 1 mm and 5 mm, in particular, between 1 mm and 3 mm.

The number of adhesive discharge nozzles is preferably between 20 and 200. What has proven especially effective are devices that have 50 to 100 adhesive discharge nozzles—in particular, arranged in two parallel rows, preferably laterally offset relative to each other.

The adhesive discharge nozzles can be composed of the material of the adhesive distribution housing or of a different material. In the simplest embodiment, the holes or slits are incorporated in the base of the adhesive distribution housing. It has been found, however, that this results in increased cleaning cost since nozzles of this type become easily plugged, especially after extended use or extended down times. A preferred embodiment therefore uses replaceable removable adhesive discharge nozzles.

In this case, a plurality of drilled holes is provided in the adhesive distribution housing into which replaceable removable adhesive discharge nozzles are inserted. This has the great advantage that the replaceable adhesive discharge nozzles can be removed at little cost at regular intervals and replaced by new adhesive discharge nozzles. These replaceable adhesive discharge nozzles can be easily fabricated out of various plastics. It is especially advantageous if these plastics are distinguished by the fact that the adhesion of the adhesive to this plastic is as poor as possible so that the nozzle replacement intervals are as long as possible. Replaceable adhesive discharge nozzles composed of polyethylene or polypropylene have proven to be especially effective. Polyethylene or polypropylene are furthermore simple to produce and are especially inexpensive. The drilled holes are preferably designed such that they are of only minimally greater diameter than the outside diameter of the corresponding replaceable adhesive discharge nozzles, with the result that, although the adhesive discharge nozzles can easily be replaced, they nevertheless remain in place within the drilled hole without additional retaining means and do not, for example, unintentionally fall out or slide out.

It is also possible for the nozzle to be closable. The closing mechanism is, in particular, controlled by a computer. This also enables such individual closing means to be closed precisely and individually, and thus individual adhesive discharge nozzles to be closed in a precise individual fashion. This is important in particular whenever the goal is precisely to not apply a coat of adhesive to certain subsections of the planar substrate to be bonded. This may be required, for example, whenever the substrate to be joined is smaller than the substrate to be bonded. This is furthermore important for substrates to be bonded that have openings, such as those occurring, for example, in doors that have cutouts for glass sections. This capability enables the quantity of adhesive to be reduced significantly. The use of computer controls for closing the adhesive discharge nozzles, and optionally for orienting the gas discharge nozzles and/or the adhesive discharge nozzles, allows for the adhesive to be applied in very complex coating patterns to the substrate to be bonded, thereby very significantly enlarging the possible areas of application for these adhesive application devices.

In terms of the adhesive, primarily those adhesives are usable that have a viscous or viscoelastic consistency.

If adhesives have an excessively low viscosity, they tend to flow beyond the edges of the substrate to be bonded. This results in large quantities of waste and makes it impossible to maintain the thickness of an adhesive layer at the normally desired thickness of more than 0.1 mm, preferably, between 0.2 mm-1 mm.

If the viscosity is too high, problems are created in terms of delivery and achieving a homogeneous distribution of adhesive.

An optimal adhesive should thus be capable of being spread manually using a spatula—preferably at the application temperature. At the application temperature, the adhesive typically has a viscosity of 0.5 to 5 Pas.

The adhesive can be, for example, a single-component or two-component aqueous dispersion adhesive. What is preferred in terms of this type of dispersion adhesive is an aqueous polyurethane and/or acrylate dispersion adhesive, and preferably, a high-filler-content adhesive, i.e., one having a filler component of more than 70% by weight, in particular, more than 80% by weight.

The adhesive can be, for example, a nonreactive or reactive hot melt adhesive. Adhesives of this type are available, for example, from Sika Automotive GmbH under the trade name SikaMelt®. In this case, it is advantageous to heat the device and/or the delivery lines.

Especially preferred are reactive, room-temperature-setting adhesives, in particular, two-component adhesives.

Room-temperature-setting, two-component adhesives most importantly include two-component epoxy resin adhesives and two-component polyurethane adhesives.

Two-component adhesives of this type are very well-known to the person skilled in the art and are available, for example, from Sika Denmark A/S under the trade name SikaForce®.

Another preferred class of adhesives is single-component, moisture-curing polyurethane adhesives based on isocyanate polymers. Adhesives of this type are available, for example, under the trade name Sikaflex® from Sika Schweiz AG, or under the trade name SikaForce® from Sika Denmark A/S.

The adhesive discharge nozzles and gas discharge nozzle are oriented such that the outflow directional axis of the adhesive discharge nozzles and the outflow directional axis of the gas discharge nozzle describe an acute angle α.

This acute angle preferably has a value between 70° and 2°, in particular, between 5° and 45°, preferably between 10° and 30°. Homogenization of the adhesive application is especially efficient at these acute angles.

In the event multiple gas discharge nozzles are provided, each gas discharge nozzle or each group of gas discharge nozzles can have a different orientation and be at different acute angles. Depending on the rate of motion and viscosity of the adhesive, it can be useful in particular for the gas discharge nozzles present on different sides of the adhesive discharge nozzles to have different orientations such that the outflow directional axis of the adhesive discharge nozzles and the outflow directional axis of the respective gas discharge nozzles describe different acute angles α.

In another embodiment, the gas discharge nozzles are designed to be movable, in particular, swivelable. This can be implemented, for example, by a cylinder that is rotatably mounted in the device, where the cylinder has a slit.

It is of course obvious to the person skilled in the art that the gas discharge nozzles, both individually or also all of them, can be oriented automatically using appropriate means of movement, for example, by a computer, or motors connected thereto, thereby enabling angle α to be adjusted. In addition, it is similarly possible for the orientation of the gas discharge nozzles, and thus acute angle α, to be varied during the application of adhesive.

This, for example, enables relatively complex substrate surfaces, in particular, formed or curved substrate surfaces to be coated in a precisely homogeneous manner with adhesive.

The adhesive distribution housing has at least one plurality of adhesive discharge nozzles and at least one adhesive inlet orifice. One adhesive inlet orifice is preferably provided that is preferably disposed at the center relative to the longitudinal extent of the longitudinal adhesive distribution housing. However, it is also possible to provide multiple inlet orifices. In the event this is done, it is especially advantageous if they are distributed uniformly across the longitudinal extent of the adhesive distribution housing.

It is advantageous for the adhesive distribution housing to have an adhesive-distribution-housing compartment—in particular, in combination with a distribution plate having a plurality of passages—in order to distribute a quantity of adhesive across the entire length of the adhesive distribution housing, and thus as uniformly as possible, through the adhesive discharge nozzles. It is advantageous to provide indentations in the adhesive-distribution-housing compartment in order to retain the distribution plate in the proper position. The size, arrangement, and number of passages should be adjusted to the application parameters, in particular, the material flow rate, delivery pressure, or application rate, as well as to the viscosity of the adhesive.

It is advantageous for the compartment to be lined to allow for the simplest possible cleaning of the compartment. Appropriate lining elements for this purpose, in particular, plastic extruded parts or molded parts, are simple to produce. These may be films or jackets.

For this purpose, retaining means, in particular, indentations or steps, are preferably provided in the adhesive-distribution-housing compartment, which indentations or steps function to retain the lining elements in their desired position. These lining elements can be easily removed and replaced as required.

It is advantageous for the gas discharge nozzle(s) or gas discharge housing to be releasably attached to the adhesive distribution housing so as to ensure easy maintenance of the device. This attachment is in particular effected using bolts/screws. It is furthermore preferred that the adhesive distribution housing be of multi-part design, in particular, such that the adhesive distribution housing is constructed out of multiple adhesive distribution sub-housings that are releasably attached to each other. Bolts/screws are similarly preferred for the purpose of attaching the adhesive distribution sub-housings to each other.

The gas discharge nozzle is connected to the gas inlet orifice. Depending on requirements, a gas inlet orifice can supply only one or also multiple gas discharge nozzles. It is preferred that at least each gas nozzle housing have a separate gas inlet orifice. Where a gas discharge nozzle is of elongated shape, in particular, having an discharge orifice area with a length-to-width ratio of more than 10, in particular, 100 up to 4,000, preferably, between 1,000 and 3,000, it is advantageous for the nozzle to have two or more gas inlet orifices. Multiple gas inlet orifices are preferably distributed along the length of the gas discharge nozzle.

The adhesive distribution housing and gas discharge nozzle(s), or gas nozzle housing, are advantageously fabricated out of metal or plastic. In terms of metal, aluminum and its alloys are particularly well-suited. In terms of plastic, those plastics that can be produced efficiently by injection molding or are easily milled, in particular, are CNC-millable, are particularly well-suited. The device, the adhesive distribution housing and gas discharge nozzle(s) or gas nozzle housing, in particular, can be produced primarily by injection molding, extrusion, or milling, followed as required by conventional processing steps, such as, for example, drilling.

Adhesive and gas are typically supplied to the adhesive inlet orifice or gas inlet orifice through supply lines which have an adhesive supply conduit or gas supply conduit. These supply lines are typically pipes or hoses that are preferably connected by screw/bolt-type connections. Adhesives and gas are typically supplied to the device by pumps from a reservoir.

If the adhesive is a two-component or multi-component adhesive, it is advantageous to provide a mixer, in particular, a static mixer, within the adhesive supply conduit, the mixer being connected to the adhesive inlet orifice. In terms of delivery, the two components or multiple components are disposed in the mixer or upstream from the mixer.

In regard to another aspect, the invention relates to method for applying and distributing an adhesive in which
i) an adhesive is delivered through the at least one adhesive inlet orifice to a device as described above and exits the device through the plurality of adhesive discharge nozzles and is applied to a substrate surface; and
ii) a gas is delivered through the at least one gas inlet orifice to a device as described above, exits the device through the at least one gas discharge nozzle, and impinges on the adhesive.

What is advantageous about this method is that the device is moved over the substrate surface perpendicular to the longitudinal axis of the adhesive distribution housing at a distance ×1 between adhesive distribution housing and substrate surface. The motion can be effected by machine using a robot or computer-aided system.

In terms of the substrate, in principle all planar substrates are suitable. Especially well suited for this method are flat substrates, preferably panels.

After the adhesive has been applied, bonding is effected with the part to be joined during the open time for the adhesive, thereby producing an adhesive bond after the adhesive has cured.

The above-described device or the above-described method can thus be used for adhesively bonding planar substrates, in particular, panels.

It is particularly well-suited for adhesively bonding door panels and for sandwich-panel bonding.

### BRIEF DESCRIPTION OF THE DRAWINGS

The following discussion describes selected embodiments of the invention in more detail based on the drawings. In the drawings identical reference characters denote identical or functionally equivalent components, unless otherwise indicated. Directions of motion, or directions of flow by media are indicated by block arrows.

Here:

FIG. 1a is a schematic cross-section of a device 1 in which the gas discharge nozzle is connected to the adhesive distribution housing;

FIG. 1b is a schematic view of the bottom of device 1 comprising adhesive discharge nozzles arranged in one row;

FIG. 1c is a schematic view of the bottom of device 1 comprising adhesive discharge nozzles arranged in two rows;

FIG. 2a is a schematic cross-section of a device 1 in which the gas discharge nozzle is part of the adhesive distribution housing;

FIG. 2b is a schematic view of the bottom of device 1 comprising adhesive discharge nozzles arranged in one row;

FIG. 3a is a schematic cross-section along line AA in FIG. 3b or 3c of a particularly suitable device 1 in which the gas discharge nozzle is connected to the adhesive distribution housing;

FIG. 3b is a schematic view of the top of device 1;

FIG. 3c is a schematic longitudinal side view of device 1;

FIG. 4a is a schematic cross-section of a particularly suitable device 1, comprising movable gas discharge nozzles 8;

FIG. 4b is a schematic view of the bottom of device 1 comprising movable gas discharge nozzles 8;

FIG. 5a is a schematic perspective view in cross-section of an embodiment of a device according to the invention during the application of an adhesive onto a planar substrate;

FIG. 5b is a schematic perspective view in cross-section of a device, not according to the invention, during the application of an adhesive onto a planar substrate.

### MEANS FOR IMPLEMENTING THE INVENTION

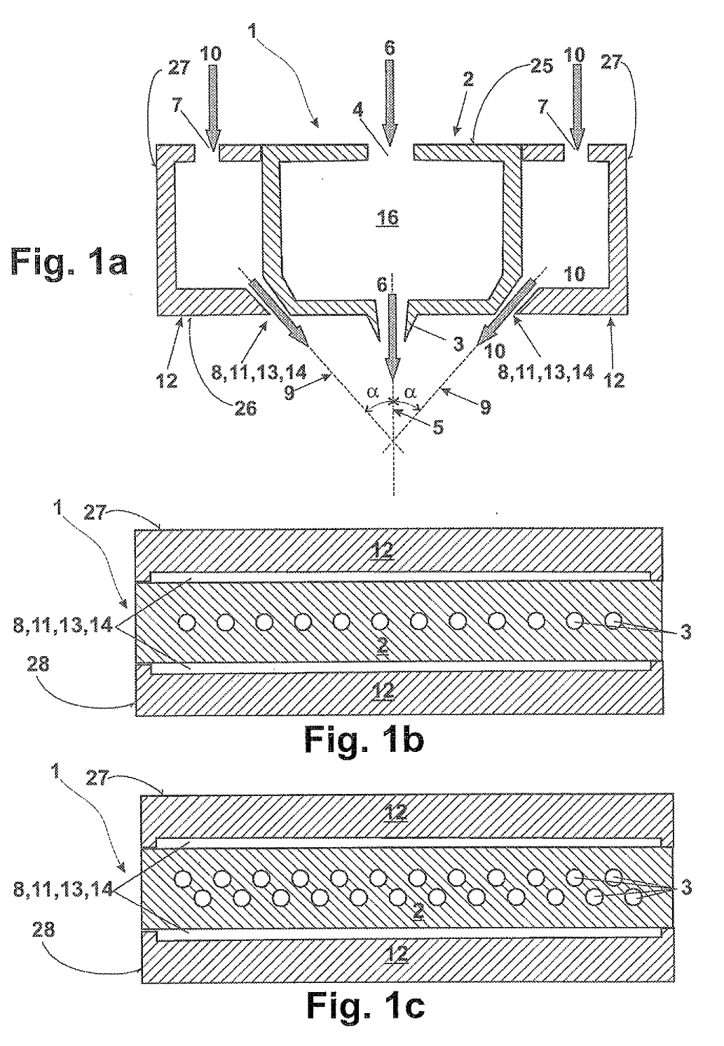

FIGS. 1a and 1c provide different schematic views and a cross-section through an embodiment of device 1 for applying adhesive in which the gas discharge nozzle is connected to the adhesive distribution housing.

FIG. 1a illustrates a cross-section of device 1 comprising an adhesive distribution housing 2 including an adhesive inlet orifice 4 and adhesive discharge nozzles 3 that are disposed on the side opposite the adhesive inlet orifice (top 25, bottom 26, respectively of device 1). The adhesive 6 is supplied to the device through the adhesive inlet orifice and flows out of the device through adhesive discharge nozzles 3 after passing through the adhesive-distribution-housing compartment 16. In addition, two gas nozzle housings 12 are connected to adhesive distribution housing 2, each housing including one gas inlet orifice 7. Gas discharge nozzles 8 are created by a gap 14 that by joining at least one gas nozzle housing 12 to adhesive distribution housing 2. The gas nozzle housing here has a cutout 2 in the region of the nozzle, thereby forming a gap 14 between adhesive distribution housing and nozzle housing, which gap functions as a gas discharge nozzle. The gas 10 is delivered through gas inlet orifice 7 to the device and flows out of the device through gas discharge nozzles 8 after passing through the gas-nozzle-housing compartment. Gas inlet orifice 7 and gas discharge nozzle 8 are thus connected to each other. The directional axis of outflow 5 for adhesive discharge nozzles 3 and directional axis of outflow 9 for gas discharge nozzle 8 here describe an acute angle α; that is, the streams of adhesive 6 and gas 10 impinge on each other at an acute angle below the device.

FIG. 1b is a schematic view of bottom 26, i.e., the side on which adhesive discharge nozzles 3 are disposed, of the embodiment of device 1, as described in FIG. 1. Adhesive discharge nozzles 3 here are arranged in the longitudinal axis of adhesive distribution housing 2 in one row.

FIG. 1c provides a view analogous to FIG. 1b of an embodiment in which adhesive discharge nozzles 3 are arranged in the longitudinal axis of adhesive distribution housing 2 in two rows that are parallel to each other and laterally offset.

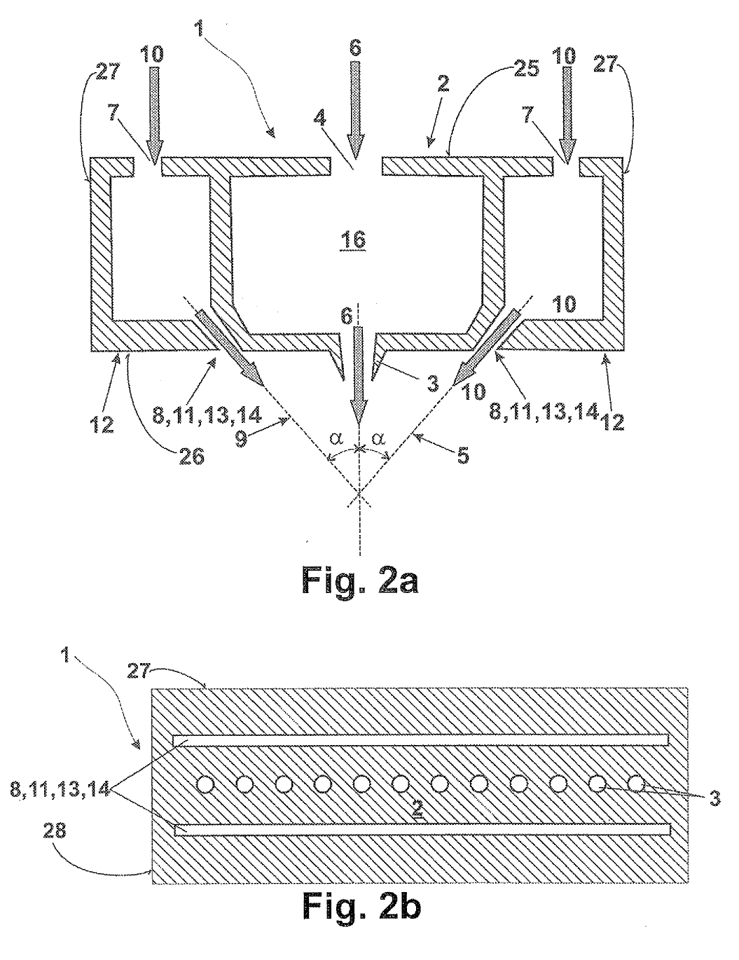

FIG. 2a and FIG. 2b provide a schematic longitudinal side view of and a cross-section through an embodiment corresponding to that of FIGS. 1a and 1b of device 1 for applying adhesive, in which, however, the gas discharge nozzle is part of the adhesive distribution housing.

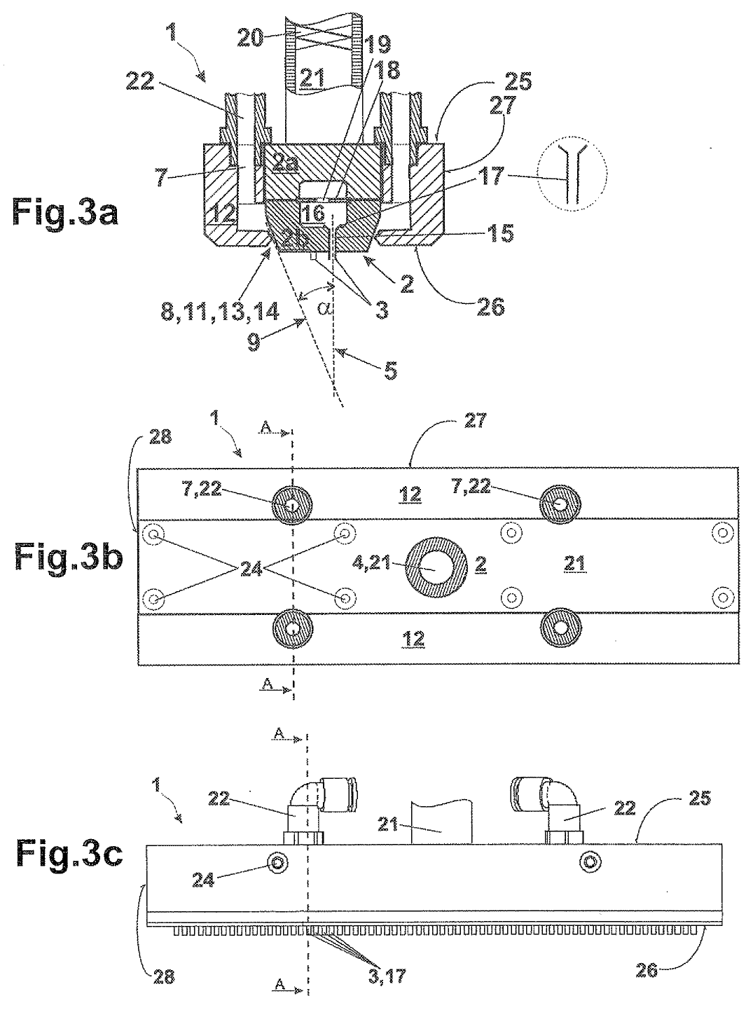

FIGS. 3a, 3b, and 3c provide various schematic views and a cross-section through a preferred embodiment of device 1 for applying adhesive in which the gas discharge nozzle is connected to the adhesive distribution housing.

Adhesive distribution housing 2 has adhesive inlet orifice 4 that is connected to an adhesive supply conduit 21. This adhesive inlet orifice is mounted centrally on the top 25 of the adhesive distribution sub-housing, or of the device. A mixer 20 is provided in this adhesive supply conduit. In terms of the mixer, a static mixer is especially suitable that mixes the two components of an adhesive (not shown in this diagram) and delivers these to the device.

In the embodiment shown here, adhesive distribution housing 2 has two adhesive distribution sub-housings 2a and 2b that are bolted/screwed together by bolts/screws 24. A distribution plate 18 comprising a plurality of passages 19 is provided in adhesive-distribution-housing compartment 16. This distribution plate is composed, in particular, of a plastic, preferably a plastic that has poor adhesion, preferably, polyolefin or Teflon®. In order to ensure simple maintenance, the two adhesive distribution sub-housings 2a and 2b have a recess along the contact edge with compartment 16 to facilitate positioning and attachment.

Two parallel, laterally offset rows of adhesive discharge nozzles 3 are provided that run in the longitudinal axis of the device on the bottom 26 of device 1. In the especially advantageous embodiment shown here, adhesive discharge nozzles 3 are implemented in the form of replaceable removable adhesive discharge nozzles 17 that are illustrated once again for purposes of clarity in the separate encircled cross-sectional diagram to the right of the main figure. Adhesive discharge nozzles 17 are advantageously fabricated out of polyolefin, in particular, polyethylene or polypropylene. Replaceable removable adhesive discharge nozzles 17 are inserted into drilled holes 15 that are provided in the adhesive distribution housing on bottom 26 of the device. The diameter of these drilled holes is sized such that adhesive discharge nozzles 17 sit snuggly, i.e., so that they cannot unintentionally fall out or slide out of the drilled holes yet are still easily removable.

Gas discharge nozzles 8 are each created by gap 14 that is created by joining the two gas nozzle housings 12 to adhesive distribution housing 2. In the region of the nozzle, the gas nozzle housing has a cutout 13, thereby creating gap 14 between adhesive distribution housing and nozzle housing, which gap functions as a gas discharge nozzle. The gas nozzle housings are bolted/screwed by bolts/screws from the longitudinal side faces 27 of the gas nozzle housing or the device to adhesive distribution housing 2 situated in-between.

Two gas inlet orifices 7 each are provided on each nozzle housing on which one gas supply line or gas supply conduit 22 is mounted. Directional axis of outflow 5 for adhesive discharge nozzles 3 and directional axis of outflow 9 for gas discharge nozzle 8 each describe here an acute angle α.

FIG. 3b is a schematic view of the top of device 1 described immediately above.

FIG. 3c is a schematic side view in the longitudinal axis of device 1.

FIG. 3a is a schematic cross-section along line AA in FIG. 3b or FIG. 3c through device

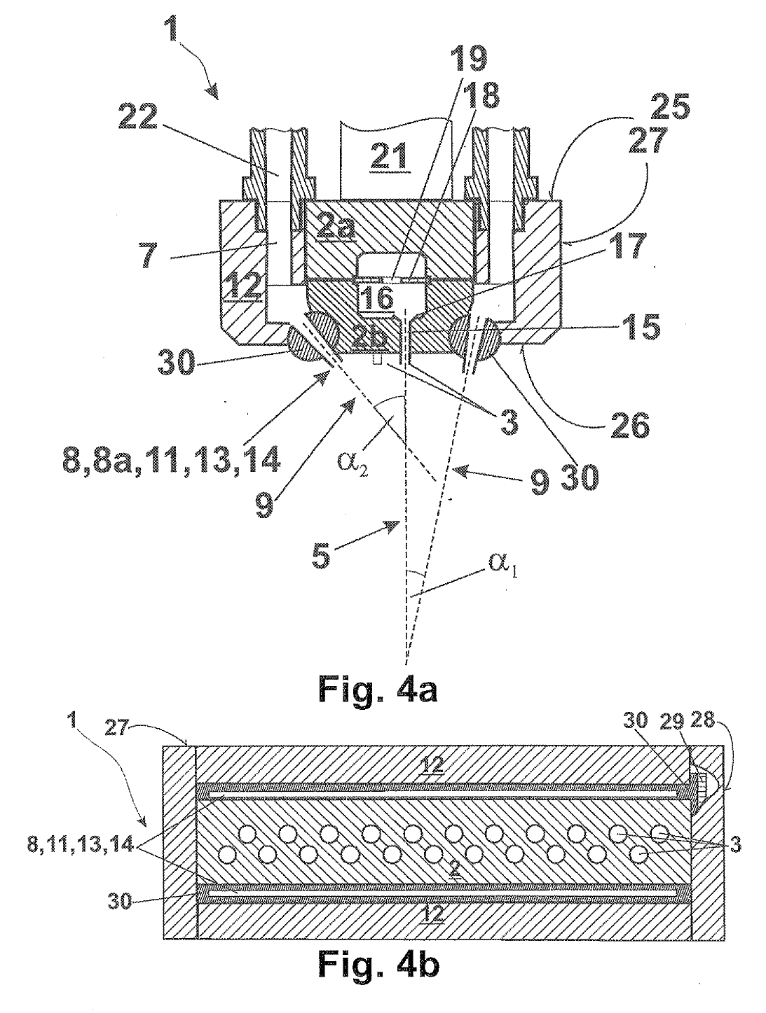

FIG. 4a is a schematic cross-section of an embodiment of device 1 comprising movable gas discharge nozzles 8. Selection of the cross-section corresponds to that of FIG. 3a. Movable gas discharge nozzles 8 in the embodiment shown here are implemented in the form of swivelable gas discharge nozzles 8a. On bottom 26 of the device, gas nozzle housing 12 and adhesive distribution housing 2 or 2b have a recess into which a rotatable cylinder 30 including a narrow slot is inserted that functions as a gas discharge nozzle.

The diagram illustrated here reveals that the size of acute angle α between directional axis of outflow 5 for adhesive discharge nozzles 3 and directional axis of outflow 9 for swivelable gas discharge nozzle 8a can be easily varied by rotating the cylinder. Swivelable gas discharge nozzle 8a shown on the left side of the diagram describes a relatively large acute angle α1, while swivelable gas discharge nozzle 8a shown on the right side of the diagram describes a relatively small acute angle α2. Angles α, or α1 and α2, of the individual swivelable nozzles can also be adjusted in various ways during the application, or can change during the application.

FIG. 4b shows bottom 26 of device 1 as just described under FIG. 4a. The motion of cylinders 30 can be effected either manually or automatically. In particular, effecting this motion automatically is possible, as shown for example in FIG. 4b, by providing at least one gear 29, which can be rotated by a motor, at one end of the cylinder. This type of motion-effecting equipment is advantageously installed within the lateral end faces 28 of the device. The lateral end face can, in particular, be bolted/screwed onto the adhesive distribution housing and/or gas nozzle housing.

In another variant, not illustrated here, the movable or swivelable gas discharge nozzle is implemented not in the form of a slit extending over most of the length of the device, but is instead in the form of multiple smaller individually or collectively movable or swivelable gas discharge nozzles. This plurality of gas nozzles can optionally be moved or swiveled either individually or in groups.

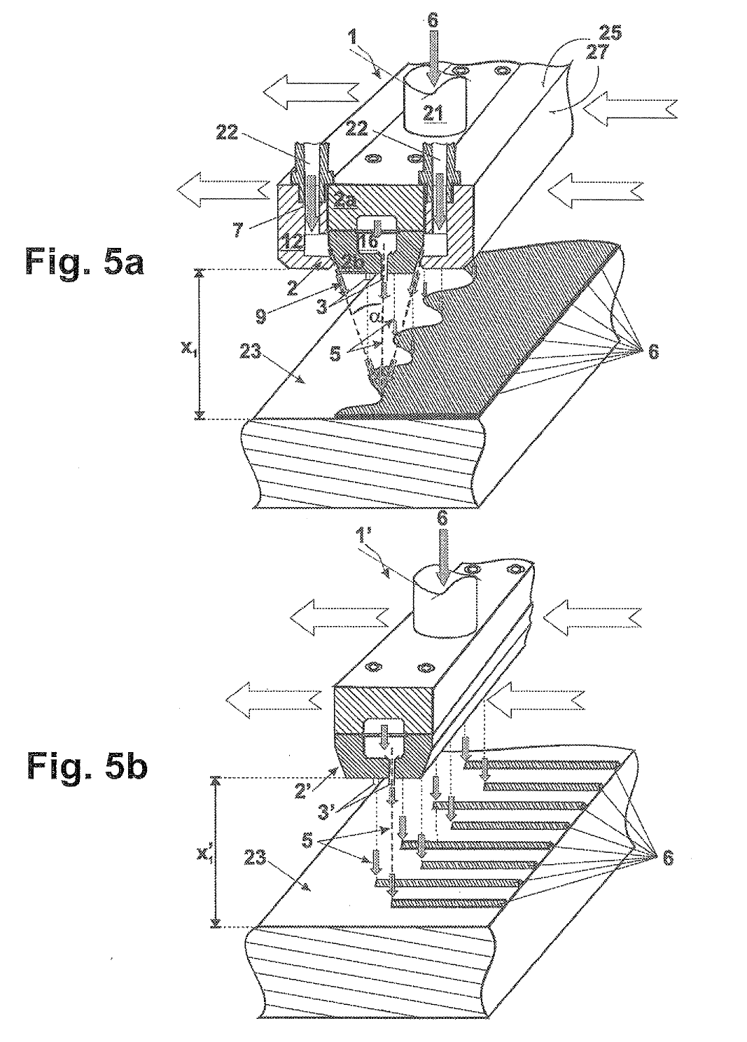

FIG. 5a is a schematic perspective cross-section of an embodiment of a device according to the invention, in particular, of device 1 as already described in detail in FIGS. 3a, 3b, and 3c, when applying and distributing an adhesive to a planar substrate. Device 1 is moved here parallel to the substrate surface at a clearance x1. Here adhesive 6 is delivered through the adhesive supply conduit to device 1, pressed out by distribution plate 18 inside adhesive-distribution-housing compartment 16 through the individual adhesive discharge nozzles, and applied to the surface of the substrate. Gas 10 is delivered through gas supply conduit 22 and gas inlet orifice 7 to device 1, more accurately, to gas nozzle housing 12, and directed through gas discharge nozzle 8 under pressure onto the adhesive. As a result of the interaction between gas stream and adhesive stream, the adhesive is swirled, and a more uniform planar application of adhesive is produced. Due to the lateral offset of the two rows of adhesive discharge nozzles, the adhesive front is formed in a slightly rippled fashion.

By way of contrast, FIG. 5b provides an analogous schematic perspective view in cross-section of a device 1′ not according to the invention when applying an adhesive to a planar substrate. Device 1 here is moved parallel to the substrate surface at a clearance xi Due to the lack of the gas discharge nozzles, the application of adhesive to the substrate surface 23 is implemented very inhomogeneously.

It is of course understood that the embodiments indicated in FIGS. 1a through 5a can be combined in any manner desired.

The invention is not restricted to the embodiments illustrated in the above figures.

### LIST OF REFERENCE CHARACTERS

1 device
2 adhesive distribution housing
2a, 2b adhesive distribution sub-housing
3 adhesive discharge nozzles
4 adhesive inlet orifice
5 directional axis of outflow for adhesive discharge nozzle 3
6 adhesive
7 gas inlet orifice
8 gas discharge nozzle
8a, 8b swivelable gas discharge nozzle
9 directional axis of outflow for gas discharge nozzle 8
10 gas
11 gap
12 gas nozzle housing
13 cutout
14 gap
15 drilled hole
16 adhesive-distribution-housing compartment
17 replaceable adhesive discharge nozzles
18 distribution plate
19 passage
20 mixer, static mixer
21 adhesive supply conduit
22 gas supply conduit
23 substrate surface
24 bolts/screws
25 top of device 1
26. bottom of device 1
27 longitudinal side face of device 1
28 lateral end face of device 1
29 gear
30 rotatable cylinder
α, α1, α2 angle between axes 5 and 9
x1 clearance between adhesive distribution housing 2 and substrate surface 23
1′ device based on prior art
2′ distribution housing based on prior art
3′ adhesive discharge nozzles based on prior art
x1′ clearance between adhesive distribution housing 2′ and passage substrate surface 23

1. Device for applying adhesive, including a longitudinal adhesive distribution housing comprising a plurality of adhesive discharge nozzles that are disposed at intervals along one side of the adhesive distribution housing, and at least one adhesive inlet orifice wherein the device furthermore has at least one gas inlet orifice, and at least one gas discharge nozzle disposed in the longitudinal axis of the adhesive distribution housing, the nozzle being part of the adhesive distribution housing or is connected to this housing, and the nozzle being connected to the gas inlet orifice, wherein the directional axis of outflow for the adhesive discharge nozzles and the directional axis of outflow for the gas discharge nozzle describe an acute angle.

2. Device according to claim 1, wherein the gas is nitrogen or air.

3. Device according to claim 1, wherein the plurality of adhesive discharge nozzles is disposed in the longitudinal axis of the adhesive distribution housing.

4. Device according to claim 1, wherein the gas discharge nozzle is created by a gap that is formed by joining at least one gas nozzle housing to the adhesive distribution housing, wherein the gas nozzle housing has a cutout in the region of the nozzle, thereby creating a gap between adhesive distribution housing and gas nozzle housing, the gap functioning as a gas discharge nozzle.

5. Device according to claim 1, wherein the acute angle has a value between 70° and 2°.

6. Device according to claim 1, wherein the device has at least two gas discharge nozzles that are disposed in the longitudinal axis of the adhesive distribution housing along different sides of the adhesive discharge nozzles.

7. Device according to claim 1, wherein a plurality of drilled holes is provided in the adhesive distribution housing, replaceable removable adhesive discharge nozzles being inserted in the holes.

8. Device according to claim 1, wherein the device furthermore has an distribution-housing compartment in which a distribution plate is provided comprising a plurality of passages.

9. Device according to claim 1, wherein a mixer is provided in one adhesive supply conduit that is connected to the adhesive inlet orifice.

10. Device according to claim 1, wherein the gas discharge nozzle is designed to be movable.

11. Method for applying and distributing an adhesive, wherein:
an adhesive is delivered through at least one adhesive inlet orifice to a device according to claim 1, and exits the device through the plurality of adhesive discharge nozzles, and is applied to a substrate surface; and
ii) a gas is delivered through the at least one gas inlet orifice to a the device, exits the device through the at least one gas discharge nozzle, and impinges on the adhesive.

12. Method according to claim 11, wherein the device is moved over the substrate surface perpendicular to the longitudinal axis of the adhesive distribution housing at a clearance between adhesive distribution housing and substrate surface.

13. Method according to claim 11, wherein the adhesive is a two-component adhesive.

14. Method according to claim 11, wherein the adhesive is polyurethane adhesive.

15. A product that bonds planar surfaces comprising:
a device according to claim 1.
